(19) United States
(12) Patent Application Publication
(10) Pub. No.: US 2011/0310238 A1
(43) Pub. Date: Dec. 22, 2011

(54) APPARATUS AND METHOD FOR INPUTTING COORDINATES USING EYE TRACKING

(75) Inventors: Eun-Jin KOH, Daejeon (KR); Jun-Seok Park, Daejeon (KR); Jeun-Woo Lee, Daejeon (KR); Jong-Ho Won, Daejeon (KR)

(73) Assignee: Electronics and Telecommunications Research Institute, Daejeon (KR)

(21) Appl. No.: 13/162,374

(22) Filed: Jun. 16, 2011

(30) Foreign Application Priority Data
Jun. 17, 2010 (KR) 10-2010-0057396

(51) Int. Cl. H04N 7/18

(52) U.S. Cl. 348/78; 348/E07.085

(57) ABSTRACT

Disclosed herein are an apparatus and method for inputting coordinates using eye tracking. The apparatus includes a pupil tracking unit, a display tracking unit, and a spatial coordinate conversion unit. The pupil tracking unit tracks the movement of a user's pupil based on a first image photographed by a first camera. The display tracking unit tracks the region of a display device located in a second image photographed by a second camera. The spatial coordinate conversion unit maps the tracked movement of the pupil to the region of the display device in the second image, and then converts location information, acquired based on the mapped movement of the pupil, into spatial coordinates corresponding to the region of the display device in the second image.

### CROSS REFERENCE TO RELATED APPLICATION

This application claims the benefit of Korean Patent Application No. 10-2010-0057396, filed on Jun. 17, 2010, which is hereby incorporated by reference in its entirety into this application.

### BACKGROUND OF THE INVENTION

1. Technical Field

The present invention relates generally to an apparatus and method for inputting coordinates using eye tracking, and, more particularly, to an apparatus and method for inputting coordinates for a gaze-based interaction system, which are capable of finding a point, which is being viewed by a user, using an image of the user's eye.

2. Description of the Related Art

Eye tracking technology and gaze direction extraction technology are topics that have been actively researched so as to implement a new user input method in the Human-Computer Interaction (HCI) field. Such technologies have been developed and commercialized to enable physically impaired persons, who cannot freely move their bodily parts, such as their hands or feet, to use devices such as computers.

Eye tracking technology and gaze direction extraction technology are used in the various data mining fields, for example, in such a way as to investigate the gaze trajectories of users depending on the arrangement of advertisements or text by tracking locations which are viewed by not only physically impaired persons but also general users.

The most important part of eye tracking is the tracking of the pupil. Thus far, various methods for tracking the pupil have been used.

For example, these methods include a method using the fact that light is reflected from the cornea, a method using the phenomenon which occurs when light passes through various layers of the eye having different refractive indices, an electrooculography (EOG) method using electrodes placed around the eye, a search coil method using a contact lens, and a method using the phenomenon where the brightness of the pupil varies depending on the location of a light source.

Furthermore, when the method of tracking the pupil is used in practice, there are used firstly a method of extracting a gaze direction by analyzing the relationship between the head and the eye based on information about the movement of the head extracted using a magnetic sensor and the locations of points obtained by tracking the eyeball (the iris or the pupil) using a camera in order to compensate for the movement of the head; and secondly, a method of estimating a gaze direction based on variation in input light depending on the gaze direction by using a device for receiving light reflected from a projector and the eye.

### SUMMARY OF THE INVENTION

Accordingly, the present invention has been made keeping in mind the above problems occurring in the prior art, and an object of the present invention is to provide an apparatus and method for inputting coordinates, which are configured to photograph images of the user's pupil and the user's front using at least two cameras, track a gaze direction depending on the movement of the location of the pupil in a user's visible region and then convert the results of the tracking into spatial coordinates, so that it is possible to track a location which is being viewed by a user regardless of the movement of the user's head.

In order to accomplish the above object, the present invention provides an apparatus for inputting coordinates using eye tracking, including a pupil tracking unit for tracking movement of a user's pupil based on a first image photographed by a first camera; a display tracking unit for tracking a region of a display device located in a second image photographed by a second camera; and a spatial coordinate conversion unit for mapping the tracked movement of the pupil to the region of the display device in the second image, and then converting location information, acquired based on the mapped movement of the pupil, into spatial coordinates corresponding to the region of the display device in the second image.

The first camera may be fixed onto a head mount worn on the user's head, and may be disposed so that a lens of the first camera is oriented toward the user's eye.

The first camera may be an infrared camera including a band pass filter having a wavelength range of 1300 nm or 1900 nm.

The second camera may be fixed onto the head mount worn on the user's head beside the first camera, and may be disposed so that a lens of the second camera is oriented toward the user's gaze direction.

The second camera may photograph the second image depending on the user's gaze direction at a location which is varied by movement of the user's head.

The pupil tracking unit may track the location of the center of the pupil based on the first image photographed by the first camera.

The spatial coordinate conversion unit may calibrate the location of the center of the pupil in the space of the second image.

The spatial coordinate conversion unit may convert the location of the center of the pupil into spatial coordinates corresponding to the region of the display device in the second image based on the ratio between the region of the display device and the location of the center of the pupil.

The display tracking unit may track the locations of one or more markers, attached to the display device, in the second image.

Additionally, in order to accomplish the above object, the present invention provides a method of inputting coordinates using eye tracking, including tracking the movement of a user's pupil based on a first image photographed by a first camera; tracking a region of a display device located in a second image photographed by a second camera; and mapping the tracked movement of the pupil to the region of the display device in the second image, and then converting location information, acquired based on the mapped movement of the pupil, into spatial coordinates corresponding to the region of the display device in the second image.

The first camera may be fixed onto a head mount worn on the user's head, and may be disposed so that a lens of the first camera is oriented toward the user's eye.

The first camera may be an infrared camera including a band pass filter having a wavelength range of 1300 nm or 1900 nm.

The second camera may be fixed onto the head mount worn on the user's head beside the first camera, and may be disposed so that a lens of the second camera is oriented toward the user's gaze direction.

The second camera may photograph the second image depending on the user's gaze direction at a location which is varied by movement of the user's head.

The tracking movement of a user's pupil may track the location of the center of the pupil based on the first image photographed by the first camera.

The mapping may include calibrating the location of the center of the pupil in the space of the second image.

The converting may convert the location of the center of the pupil into spatial coordinates corresponding to the region of the display device in the second image based on the ratio between the region of the display device and the location of the center of the pupil.

The tracking a region of a display device may include tracking the locations of one or more markers, attached to the display device, in the second image.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the configuration of a system to which an apparatus for inputting coordinates according to the present invention has been applied;

FIG. 2 is a view showing the apparatus for inputting coordinates according to the present invention;

FIG. 3 is a block diagram illustrating the configuration of the apparatus for inputting coordinates according to the present invention;

FIG. 4 is a diagram illustrating the principle of the operation of the cameras of the apparatus for inputting coordinates according to the present invention;

FIG. 5 is a diagram showing an example of a visible screen region according to the present invention;

FIGS. 6 and 7 are diagrams illustrating the operation of tracking a gaze direction in a visible screen region according to the present invention; and

FIG. 8 is a flowchart showing the flow of a method of inputting coordinates according to the present invention.

### DESCRIPTION OF THE PREFERRED EMBODIMENTS

Reference now should be made to the drawings, in which the same reference numerals are used throughout the different drawings to designate the same or similar components.

Embodiments of the present invention will be described below with reference to the accompanying drawings.

In general, methods using cameras in eye tracking may be classified into two types. The first type of method is to place cameras around a user's eye in head-mounted form, and the second type of method is to place cameras on a monitor side and photograph a user's eye over a long distance.

Although the method of capturing a user's eye over a long distance has the advantage of wearing nothing on his or her body, the movement of a user's head is limited, accuracy is reduced because the method of calculating the relative locations between a monitor, the head and the eye is complicated, or the resolution of a camera should be sufficiently high. Furthermore, the method of capturing a user's eye over a long distance is disadvantageous in that a camera and various additional devices should be moved from a monitor to another monitor in a calibrated state so as to apply the method to the other monitor because a camera is attached to the former monitor.

Accordingly, in the present invention, the method using head-mounted type cameras is used to track a user's gaze direction.

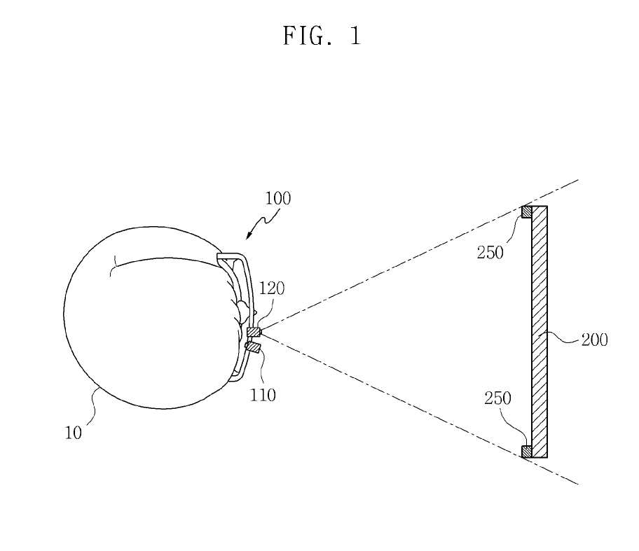

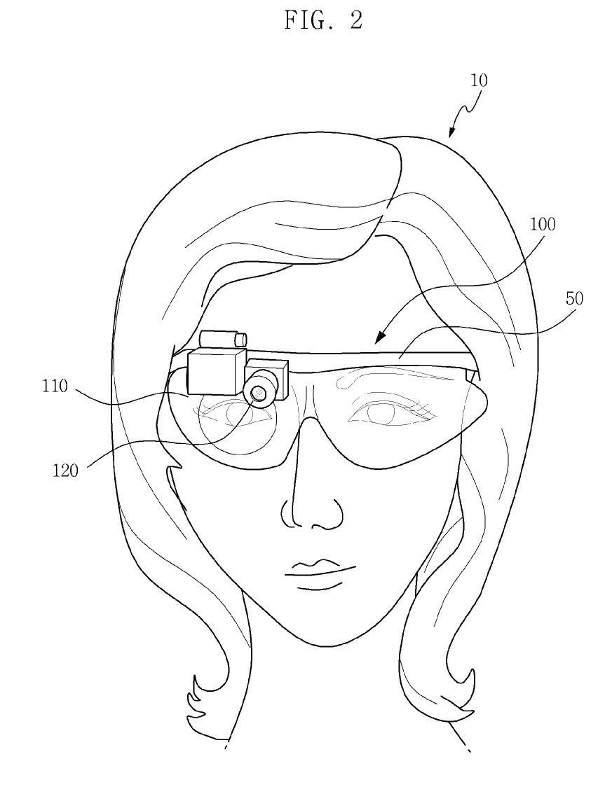

FIG. 1 is a diagram showing the configuration of a system to which an apparatus 100 for inputting coordinates according to the present invention has been applied, and FIG. 2 is a view showing the apparatus for inputting coordinates according to the present invention.

As shown in FIGS. 1 and 2, the apparatus 100 for inputting coordinates according to the present invention is implemented using a head mount 50. At least two cameras are arranged on the head mount 50.

Here, at least one camera photographs an image of a user's eye, and another at least one camera photographs an image of the user's front view. For convenience's sake, at least one camera is referred to as a first camera 110, and another at least one camera is referred to as a second camera 120.

The first camera 110 is fixed onto the head mount 50, and the lens of the first camera 110 is fixed and disposed so that it is oriented toward the user's eye when the head mount 50 is worn on the user's head 10. That is, the first camera 110 fixedly photographs an image of the user's eye even if a gaze direction is changed by the movement of the user's head 10.

Here, although it is preferred that the first camera 110 be an infrared camera provided with a band pass filter for a wavelength range of 1300 nm or 1900 nm, it is not limited thereto.

A method using infrared light when capturing the eye can prevent illumination from being reflected from the pupil and also it is easy to directly track the pupil rather than the limbus because the method does not utilize surrounding light.

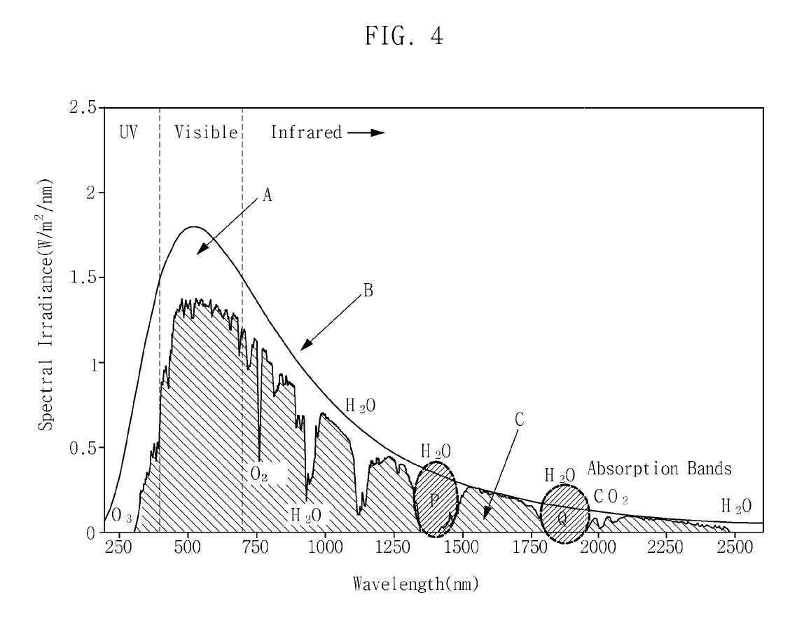

Moreover, the first camera 110 photographs an image of the eye in a wavelength range of 1300 nm or 1900 nm, so that it is possible to track the movement of the pupil outdoors. A detailed description thereof will now be given with reference to FIG. 4.

The second camera 120 is fixed onto the head mount 50 beside the first camera 110, and the lens of the second camera 120 is fixed and disposed so that it is oriented toward a direction opposite to the direction of the user's eye, that is, the user's gaze direction, when the head mount 50 is worn on the user's head 10. That is, when the gaze direction is changed by the movement of the user's head 10, the second camera 120 photographs a frontal image of a visible region in the gaze direction in which the user's eye is oriented toward the changed location.

Here, although the second camera 120 may be an infrared camera provided with a band pass filter having a wavelength range of 1300 nm or 1900 nm, like the first camera 110, it is not limited thereto.

In greater detail, the second camera 120 photographs a display device 200 which is located in front of the user. In this case, markers 250 are attached to the display device 200 located in front of the user to enable the location, shape and the like of the display device 200 to be detected. It will be apparent that the markers 250 may be provided in the form which is contained inside the display device 200. Here, infrared light emitting devices, for example, Light-Emitting Diodes (LEDs), may be used as the markers 250.

Although the markers 250 are attached to the four corners of the display device 200, the markers 250 are not limited to a specific shape or a number because they are used to detect the location, shape and the like of the display device 200.

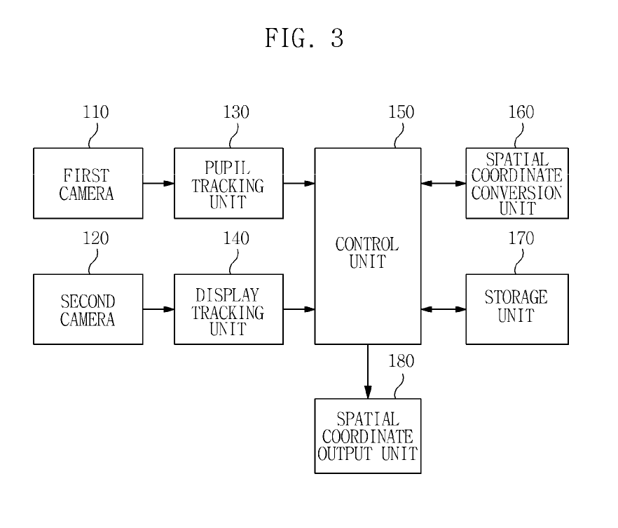

Referring to FIG. 3, the configuration of the apparatus for inputting coordinates according to the present invention will now be described in greater detail. FIG. 3 is a block diagram illustrating the configuration of the apparatus for inputting coordinates according to the present invention.

As shown in FIG. 3, the apparatus 100 for inputting coordinates according to the present invention includes a first camera 110, a second camera 120, a pupil tracking unit 130, a display tracking unit 140, a control unit 150, a spatial coordinate conversion unit 160, a storage unit 170, and a spatial coordinate output unit 180. Here, the control unit 150 controls the operation of the first camera 110, the second camera 120, the pupil tracking unit 130, the display tracking unit 140, the spatial coordinate conversion unit 160, the storage unit 170 and the spatial coordinate output unit 180.

For the first camera 110 and the second camera 120, reference is made to the descriptions of FIGS. 1 and 2.

Meanwhile, the pupil tracking unit 130 tracks the movement of the user's pupil in images of the user's eye (hereinafter referred to as the “first images”) photographed by the first camera 110. In greater detail, the pupil tracking unit 130 tracks the center location of the pupil based on the first images photographed by the first camera 110.

The display tracking unit 140 tracks the region of the display device 200 which is located in images of the user's front (hereinafter referred to as the “second images”) photographed by the second camera 120. Here, the display tracking unit 140 tracks the region of the display device 200 by tracking the locations of the markers 250, attached to the display device 200, in the second images.

The spatial coordinate conversion unit 160 maps the movement of the pupil, tracked in the first images, to the region of the display device 200 in the second images.

Furthermore, the spatial coordinate conversion unit 160 converts location information, acquired based on the mapped movement of the pupil, into spatial coordinates corresponding to the region of the display device 200 in the second images.

Here, the spatial coordinate conversion unit 160 performs conversion into spatial coordinates corresponding to the region of the display device 200 in the second image based on the ratio between the region of the display device 200 and the location of the center of the pupil.

Here, the spatial coordinate conversion unit 160 performs calibration in the space of the second image based on the location of the center of the pupil. The spatial coordinate conversion unit 160 performs calibration in advance.

Calibration is the process of creating function f_{c}(x) which is used to calculate the location of a second image to which the location of the center of the pupil acquired from a first image is oriented. Here, f_{c}(x) does not convert the coordinates of the center of the pupil, acquired from the first image, into coordinates on the display device 200, but converts the coordinates of the center of the pupil, acquired from the first image, into coordinates in the second image.

Furthermore, since f_{c}(x) is not a fixed function but may vary depending on the location of the pupil based on a first image and depending on a second image, the equation of f_{c}(x) is not mentioned in the embodiment of the present invention.

Accordingly, the spatial coordinate conversion unit 160 enables location information, acquired based on the movement of the pupil, to be converted into spatial coordinates corresponding to the region of the display device 200 in the second image by applying the location of the center of the pupil, acquired from the first image, and the locations of the markers 250, acquired from the second image, to the calibrated f_{c}(x).

The storage unit 170 stores the first and second images photographed by the first camera 110 and the second camera 120. Furthermore, the storage unit 170 further stores information about the location of the center of the pupil tracked by the pupil tracking unit 130 and information about the location of the region of the display device 200 tracked by the display tracking unit 140. Moreover, the storage unit 170 stores function f_{c}(x) created by the calibration of the spatial coordinate conversion unit 160 and spatial coordinate values obtained by function f_{c}(x).

The spatial coordinate output unit 180 outputs the coordinate information, obtained by the spatial coordinate conversion unit 160, to a control device which is connected to the apparatus 100 for inputting coordinates according to the present invention.

FIG. 4 is a diagram illustrating the principle of the operation of the cameras of the apparatus for inputting coordinates according to the present invention. In greater detail, FIG. 4 shows solar radiation spectra, and is a wavelength vs. spectral irradiance graph for solar light.

In the graph of FIG. 4, the X axis represents wavelength in nm. Meanwhile, the Y axis represents spectral irradiance in W/m²/nm.

Furthermore, in FIG. 4, “A” is the spectrum of solar light above the atmosphere, and “B” is a blackbody spectrum at a temperature of 5250° C. Furthermore, “C” is the spectrum of radiation at sea level.

As shown in FIG. 4, it can be seen that radiation at sea level is not performed in wavelength ranges of 1300 nm and 1900 nm, which belong to the infrared light band. That is, it can be seen that infrared light in wavelength ranges of 1300 nm and 1900 nm does not easily reach the Earth's surface.

Accordingly, in the present invention, the locations of the pupil and the markers 250 are tracked using infrared light in wavelength ranges near 1300 nm and 1900 nm. In this case, not only can more robust images be acquired under solar light, but power consumption can also be reduced.

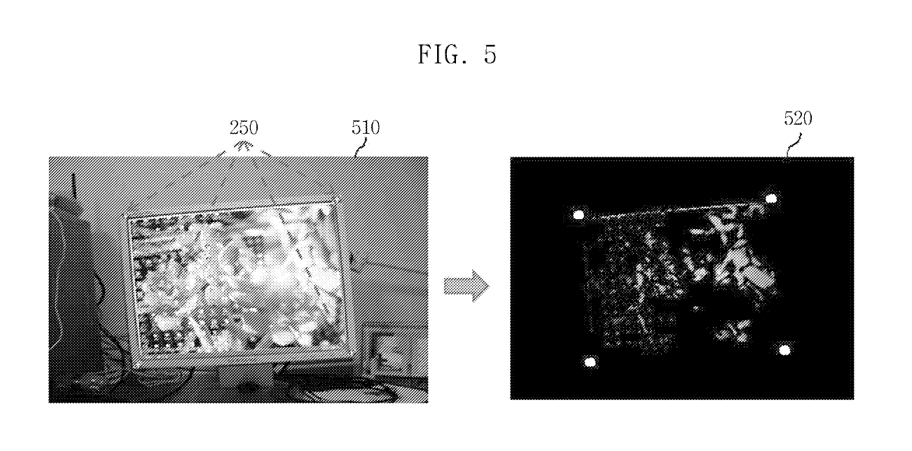

FIG. 5 is a diagram showing an example of a visible screen region according to the present invention.

In FIG. 5, reference numeral ‘510’ denotes an image in which a user wearing the head mount 50 on his or her head 10 views the display device 200, on the corners of which the markers 250 have been attached, and reference numeral ‘520’ denotes an image that is actually photographed by the second camera 120 mounted on the head mount 50. Although in the following embodiment, an example in which the markers 250 have been disposed on respective corners of the display device 200 will be given, the present invention is not limited thereto.

In order to perform calibration, the user views the markers 250 attached to the display device 200, with his or her head 10 being fixed as much as possible. It is preferable to fill the second image with the display device 200 if possible.

Although according to the present invention, it is unnecessary for the user to view the markers 250 with his or her head 10 fixed, or it is unnecessary to fill the second image with the display device 200, it is preferable to fill the second image with the display device 200 so as to increase accuracy.

The pupil tracking unit 130 stores the location of the center of the pupil in the storage unit 170 when the user views each of the markers 250.

For example, with regard to the pupil tracking unit 130, when the user views the markers 250 attached to the display device 200 of FIG. 5, four sets of coordinates of the centers of the pupil correspond to the four corners of a virtual display shape (a rectangle).

Once the coordinates of the four corners are known, the spatial coordinate conversion unit 160 creates function f_{c}(x), which can calculate the portion of the second image which is being viewed by the user, using various methods, even if the user views a location other than the markers 250.

Since the second camera 120 is affixed onto the user's head 10, the second image photographed by the second camera 120 is varied by the movement of the user's head 10.

Here, f_{c}(x) indicates the portion of the second image, varied by the movement of the user's head 10, which is being viewed by the user. That is, f_{c}(x) is a spatial coordinate conversion function which has the coordinates of the center of the pupil of the user, acquired from the first image, as input and has specific coordinates of the second image as output.

Once f_{c}(x) has been determined as described above, it is unnecessary for the spatial coordinate conversion unit 160 to obtain it, as long as the locations of the first and second cameras 110 and 120 or the characteristics of the cameras (focal length or the like) do not change.

Although in the embodiment of the present invention, the process of obtaining f_{c}(x) using the markers 250 attached to the display device 200 has been described, any method can be used to obtain f_{c}(x) because the ultimate objective is to obtain f_{c}(x). That is, even when f_{c}(x) is obtained using the three points of a triangle, the operation of the present invention can track the portion of the display device 200 which is being viewed by the user.

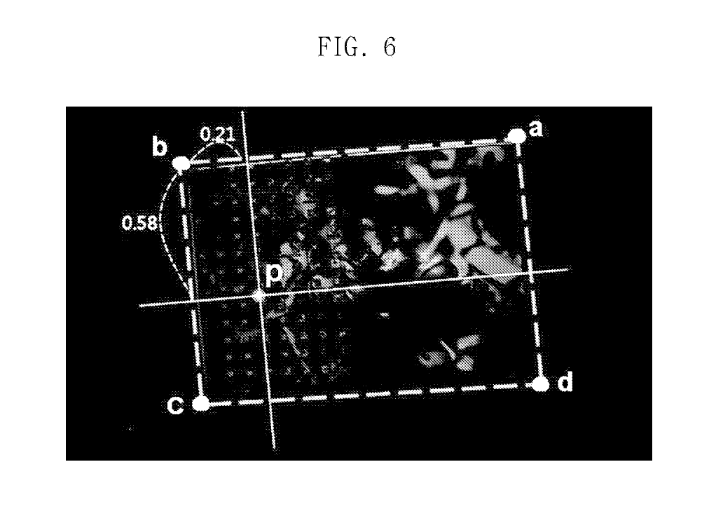

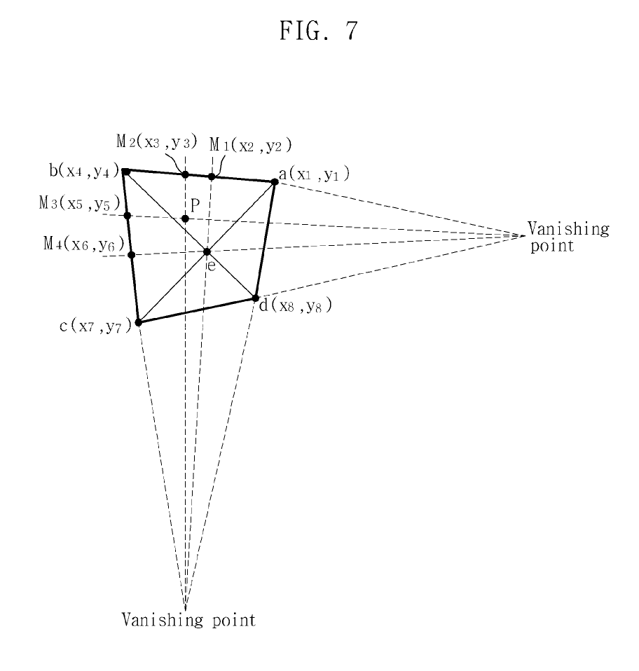

FIGS. 6 and 7 are diagrams illustrating the operation of tracking a gaze direction in a visible screen region according to the present invention.

First, FIG. 6 shows the locations of the markers 250 and the location of the center of the pupil in an image acquired by the second camera 120, like FIG. 5.

Here, “a,” “b,” “c,” and “d” denote the locations of the markers 250, and “P” denotes the location of the center of the pupil.

Furthermore, a rectangle that connects “a,” “b,” “c,” and “d” corresponds to the region of the display device 200.

Accordingly, the spatial coordinate conversion unit 160 estimates the portion of the actual display device 200 that is being viewed by the user by calculating the ratio between the rectangle abcd and P.

In the embodiment of FIG. 6, an example in which the region of the display device 200 is a rectangle is taken to describe a method of more simply calculating the location of “P.”

Meanwhile, the case where the region of the display device 200 is not a rectangle occurs due to the photograph angle of the second camera 120. In this case, a method of calculating the location of “P” will now be described with reference to FIG. 7.

In FIG. 7, the points a, b, c and d and the location P of the user's pupil location correspond to a, b, c and d, and P in FIG. 6. Here, it is assumed that the coordinates of the locations a, b, c and d of the markers 250 are a(x₁, y₁), b(x₄, y₄), c(x₇, y₇) and d(x₈, y₈). Meanwhile, in FIG. 7, e is the midpoint of a, b, c and d.

Here, a vanishing point can be found from a, b, c and d, point (M₂, M₃) at which a rectilinear line passing through the vanishing point and P meets a̅b̅ and b̅c̅ can be found, and point (M₁, M₄) at which a rectilinear line passing through the vanishing point and e meets a̅b̅ and b̅c̅ can be found.

Here, it is (assumed that the coordinates of M₁, M₂, M₃ and M₄ are M₁(x₂, y₂), M₂(x₃, y₃), M₃(x₅, y₅) and M₄(x₆, y₆).

Accordingly, when the display device 200 is plane, the location coordinates (Xₚ, Yₚ) of P can be obtained using the following Equation 1:

$${C}_{x} = \frac{( {x}_{4} {y}_{2} - {x}_{2} {y}_{4} ) ( {x}_{3} {y}_{4} - {x}_{4} {y}_{3} )}{( {x}_{1} {y}_{5} - {x}_{5} {y}_{1} ) ( {x}_{1} {y}_{2} - {x}_{2} {y}_{1} )} \\ {C}_{y} = \frac{( {x}_{4} {y}_{6} - {x}_{6} {y}_{4} ) ( {x}_{5} {y}_{4} - {x}_{4} {y}_{5} )}{( {x}_{7} {y}_{5} - {x}_{5} {y}_{7} ) ( {x}_{6} {y}_{7} - {x}_{7} {y}_{6} )} \\ {X}_{p} = \frac{w {C}_{x}}{1 + {C}_{x}} \\ {Y}_{p} = \frac{h {C}_{y}}{1 + {C}_{y}} \qquad ( 1 )$$

Here, Equation 1 is based on f_{c}(x).

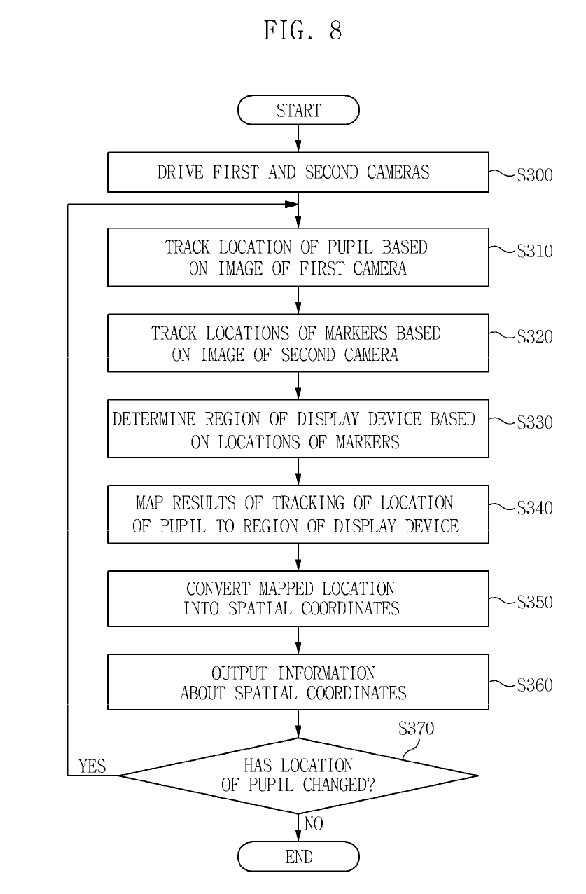

FIG. 8 is a flowchart showing the flow of a method of inputting coordinates according to the present invention.

Referring to FIG. 8, when the first and second cameras 110 and 120 of the apparatus 100 for inputting coordinates are operated at step S300, the pupil tracking unit 130 tracks the location of the user's pupil in a first image photographed by the first camera 110 at step S310. Furthermore, the display tracking unit 140 tracks the locations of the marker 250 in a second image photographed by the second camera 120 at step S320. Here, the display tracking unit 140 determines a visible screen region based on the locations of the markers 250 in the second image, and tracks the region of the display device 200 in the visible screen region at step S330.

Thereafter, the spatial coordinate conversion unit 160 maps the results of the tracking of the location of the pupil to the visible screen region at step S340, and converts the mapped location of the pupil into spatial coordinates at step S350.

Of course, the spatial coordinate conversion unit 160, prior to the performance of steps S340 and S350, creates a function by performing calibration on the location of the pupil in the visible screen region. At this time, the spatial coordinate conversion unit 160 converts the location of the pupil, mapped to the visible screen region, into spatial coordinates using the created function.

Finally, the spatial coordinate output unit 180 outputs spatial coordinate information obtained at step S350, thereby inputting coordinates based on the tracking of the gaze direction at step S360.

If the location of the pupil has changed at step S370, steps S310 to S360 are repeated until the input of coordinates is terminated.

Although in the embodiment of the present invention, the process of determining the portion of a display device in a visible screen region, which is being viewed by a user has been described, it will be apparent that the present invention may be applied to any object to which markers have been attached, such as a poster and a signboard, in addition to the display device.

The present invention is advantageous in that a gaze direction depending on the movement of the location of the pupil in a user's visible region is tracked based on images of the user's pupil and the user's front photographed using at least two cameras and then the results of the tracking are transformed into spatial coordinates, so that it is possible to track a location which is being viewed by a user regardless of the movement of the user's head or the resolution of the screen.

Furthermore, the present invention is advantageous in that once calibration has been performed, it is unnecessary to perform calibration again even when a display device in a visible screen region changes.

Furthermore, the present invention is advantageous in that power consumption can be reduced compared to that in the case where light source reflected from the eye is photographed by a camera because markers, that is, light sources, attached or embedded in a display device are directly photographed by a camera, and in that robust detection can be achieved outdoors because solar light in the wavelength range, which does not easily reach the Earth's surface, is utilized.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for inputting coordinates using eye tracking, comprising:
a pupil tracking unit for tracking movement of a user's pupil based on a first image photographed by a first camera;
a display tracking unit for tracking a region of a display device located in a second image photographed by a second camera; and
a spatial coordinate conversion unit for mapping the tracked movement of the pupil to the region of the display device in the second image, and then converting location information, acquired based on the mapped movement of the pupil, into spatial coordinates corresponding to the region of the display device in the second image.

2. The apparatus as set forth in claim 1, wherein the first camera is fixed onto a head mount worn on the user's head, and is disposed so that a lens of the first camera is oriented toward the user's eye.

3. The apparatus as set forth in claim 1, wherein the first camera is an infrared camera including a band pass filter having a wavelength range of 1300 nm or 1900 nm.

4. The apparatus as set forth in claim 1, wherein the second camera is fixed onto the head mount worn on the user's head beside the first camera, and is disposed so that a lens of the second camera is oriented toward the user's gaze direction.

5. The apparatus as set forth in claim 1, wherein the second camera photographs the second image depending on the user's gaze direction at a location which is varied by movement of the user's head.

6. The apparatus as set forth in claim 1, wherein the pupil tracking unit tracks a location of a center of the pupil based on the first image photographed by the first camera.

7. The apparatus as set forth in claim 6, wherein the spatial coordinate conversion unit calibrates the location of the center of the pupil in a space of the second image.

8. The apparatus as set forth in claim 6, wherein the spatial coordinate conversion unit converts the location of the center of the pupil into spatial coordinates corresponding to the region of the display device in the second image based on a ratio between the region of the display device and the location of the center of the pupil.

9. The apparatus as set forth in claim 1, wherein the display tracking unit tracks locations of one or more markers, attached to the display device, in the second image.

10. A method of inputting coordinates using eye tracking, comprising:
tracking movement of a user's pupil based on a first image photographed by a first camera;
tracking a region of a display device located in a second image photographed by a second camera; and
mapping the tracked movement of the pupil to the region of the display device in the second image, and then converting location information, acquired based on the mapped movement of the pupil, into spatial coordinates corresponding to the region of the display device in the second image.

11. The method as set forth in claim 10, wherein the first camera is fixed onto a head mount worn on the user's head, and is disposed so that a lens of the first camera is oriented toward the user's eye.

12. The method as set forth in claim 10, wherein the first camera is an infrared camera including a band pass filter having a wavelength range of 1300 nm or 1900 nm.

13. The method as set forth in claim 10, wherein the second camera is fixed onto the head mount worn on the user's head beside the first camera, and is disposed so that a lens of the second camera is oriented toward the user's gaze direction.

14. The method as set forth in claim 10, wherein the second camera photographs the second image depending on the user's gaze direction at a location which is varied by movement of the user's head.

15. The method as set forth in claim 10, wherein the tracking movement of a user's pupil tracks a location of a center of the pupil based on the first image photographed by the first camera.

16. The method as set forth in claim 15, wherein the mapping comprises calibrating the location of the center of the pupil in a space of the second image.

17. The method as set forth in claim 15, wherein the converting converts the location of the center of the pupil into spatial coordinates corresponding to the region of the display device in the second image based on a ratio between the region of the display device and the location of the center of the pupil.

18. The method as set forth in claim 10, wherein the tracking a region of a display device comprises tracking locations of one or more markers, attached to the display device, in the second image.
